(19) United States
(12) Patent Application Publication
(10) Pub. No.: US 2011/0184079 A1
(43) Pub. Date: Jul. 28, 2011

(54) FIRE-RETARDANT POLYURETHANE FOAM AND PROCESS FOR PREPARING THE SAME

(75) Inventors: Charles M. Milliren, Chesterland, OH (US); Matthew J. Worthington, Rootstown, OH (US)

(73) Assignee: INTELLECTUAL PROPERTY HOLDINGS, LLC, Cleveland, OH (US)

(21) Appl. No.: 13/014,456

(22) Filed: Jan. 26, 2011

Related U.S. Application Data
(60) Provisional application No. 61/298,673, filed on Jan. 27, 2010.

(51) Int. Cl. C08J 9/35; C08L 75/04

(52) U.S. Cl. 521/56

(57) ABSTRACT

A process for preparing a polyurethane foam that contains particles of expandable graphite and a halogenated fire-retardant additive which surprisingly impart excellent fire-retardant properties to the foam and provide a stable isocyanate-reactive component having improved pot life for industrial scale production purposes. The polyurethane foam can be prepared by mixing a single isocyanate-reactive component containing the graphite and halogenated additives along with all of the polyols and other ingredients with an isocyanate component in a two-component mixing machine such as a high-pressure mixing device for applying the reaction mixture into a suitable container.

This application claims the benefit of U.S. Provisional Application No. 61/298,673, filed Jan. 27, 2010, which is incorporated herein by reference in its entirety.

### FIELD OF THE INVENTION

The present invention relates to a process for preparing a fire-retardant polyurethane foam, and in particular, to a process for preparing a fire-retardant polyurethane foam having two-component fire-retardant additive package consisting of expandable graphite and a halogenated fire-retardant additive.

### BACKGROUND

Foams are useful in many applications, as both cushioning and protective materials. In passenger vehicles and aircraft, for example, foams are commonplace as seat cushions and for sound insulation. They are also used in protective gear and clothing, such as helmets, sports padding, etc., to protect the wearer against impact trauma.

In many applications it is desirable for foams, where used, to be fire retardant. In such applications the foam would not serve as an effective fuel capable to sustain combustion once the ignition source has been removed. Numerous standards have been promulgated by governments and standards organizations to specify the degree of permissible flammability of foam materials in certain applications. For example, a stringent standard is FAA 25.853 Appendix F, Part 1 vertical burn test promulgated by the Federal Aviation Administration. To qualify under the FAA 25.853 Appendix F, Part 1 burn test a foam must cease to burn in less than 15 seconds once the ignition source has been removed, must have a burn length of less than 6 inches and also any drips must not burn for more than 3 seconds after falling.

It has proven very difficult to consistently develop foam compositions for industrial scale processing, such as utilization of a high-pressure two-component mix head, that reproducibly meet FAA 25.853 Appendix F, Part 1. Some patent literature reports polyurethane foam compositions that purportedly meet burn tests, for example U.S. Pat. No. 5,192,811. Many, for example, like U.S. Pat. Nos. 7,390,839; 6,765,035; 6,602,925 and 6,552,098, are geared toward foams that meet less stringent flammability standards. On inspection of these patents' examples it can be seen that the reported compositions were hand-mixed in laboratory-scale batches to produce small foam samples for testing. Such hand-mixed, bench-top type foams are not suitable for industrial scale production with conventional mixing heads. In others, extrusion mixing, such as in U.S. Pat. No. 7,435,762, or split polyol blends, such as in U.S. Pat. Nos. 6,353,053; 5,192,811 and 5,169,876, are used to try and solve the same problem, namely, the loss of reactivity and short pot life experienced in foam systems where the expandable graphite is incorporated wholly in only one isocyanate-reactive component. Such multi-isocyanate-reactive systems require multiple mixing cycles and tanks, which increase production time and cost. Also, multi-isocyanate-reactive systems require more complex processing equipment beyond the use of a two-component mixing machine or head. For example, U.S. Pat. Nos. 5,192,811 and 5,169,876 report making polyurethane foams using automated equipment with a three-component agitated mix-head to produce large, commercial-scale batches that would be useful to produce commercial products, wherein the foam passed FAR 25.853. However, as noted above, such split isocyanate-reactive or polyol systems do not allow for a single isocyanate-reactive blend having extended pot life.

It has been discovered that a unique additive composition for polyurethane foams can consistently produce fire-retardant foams not only in hand-made bench-scale batches, but also in commercial-scale batches using automated foam-making equipment without resorting to either the complexity of processing foam on an extruder or the expense of a three-component foam machine. A single, stable isocyanate-reactive blend having increased pot life can be made and combined with a single isocyanate component in a two-component mixing machine.

### BRIEF SUMMARY OF THE INVENTION

A process for preparing a fire-retardant polyurethane foam including the steps of preparing a single isocyanate-reactive component by mixing at least one polyol, expandable graphite having an average particle size of at least 250 microns and a halogenated fire-retardant additive, and, further, mixing the single isocyanate-reactive component and with an isocyanate component to form a fire-retardant polyurethane foam, wherein the foam passes the burn test of FAA 25.853 Appendix F, Part 1.

A process for preparing a fire-retardant polyurethane foam that passes the burn test of FAA 25.853 Appendix F, Part 1 including introducing a single isocyanate-reactive component having a pot life of at least one hour into a two-component mixing machine, wherein the single isocyanate-reactive component contains 70 to 130 parts per formula weight of one or more polyols, 15 to 25 parts per formula weight of expandable graphite having an average particle size of at least 250 microns, 15 to 25 part per formula weight of a halogenated phosphate fire-retardant additive and 0.1 to 4 parts per formula weight of a polyurethane catalyst. Further introducing an isocyanate component into the two-component mixing machine such that the two-component mixing machine is used to mix the single isocyanate-reactive component and the isocyanate component to form a fire-retardant polyurethane foam.

A fire-retardant polyurethane foam including a reaction product of essentially only an isocyanate-reactive component and an isocyanate component. The isocyanate-reactive component preferably contains 70 to 130 parts per formula weight of one or more polyols, 15 to 25 parts per formula weight of expandable graphite having an average particle size of at least 250 microns, 15 to 25 part per formula weight of a halogenated fire-retardant additive and 0.1 to 4 parts per formula weight of a polyurethane catalyst. The fire-retardant polyurethane foam passes the burn test of FAA 25.853 Appendix F, Part 1.

### DETAILED DESCRIPTION

As used herein, when a range such as 5-25 or 5 to 25 is given, this means equal to or more than or at least 5 and, separately and independently not more than or equal to or less than 25. Described herein are fire-retardant polyurethane foams suited for passing the burn test of FAA 25.853 Appendix F, Part 1, hereinafter the FAA burn test. The fire-retardant polyurethane foams are made by reacting two components; an isocyanate-reactive component and an isocyanate component, both preferably prepared separately in advance of mixing. A novel fire-retardant additive package for addition to the isocyanate-reactive component is described herein. The isocyanate-reactive component inclusive of the fire-retardant additive package can be used on an industrial scale to make the fire-retardant foams of the present invention such that the isocyanate-reactive component has a pot life of at least 1 hour, preferably at least 1.5 hours and more preferably at least 2 hours as described below.

Table 1 discloses the compositions of the isocyanate component and the isocyanate-reactive component that are mixed and reacted to provide examples of the invented fire-retardant polyurethane foam. In Table 1, for the isocyanate component, all values are weight percents with respect to the total composition of the isocyanate component. For the isocyanate-reactive component, all values are parts per formula weight with respect to the total weight of the isocyanate-reactive component. For each of the isocyanate component and isocyanate-reactive component, any less preferred or more preferred concentration or range for any one ingredient can be combined with any less preferred or more preferred concentration or range for any of the other ingredients. It is not necessary or required that all of the concentrations or ranges for all of the ingredients for either the isocyanate component or isocyanate-reactive component come from the same column or be included in either component.

TABLE 1
Isocyanate Component and Isocyanate-Reactive Component
for Fire-Retardant Polyurethane Foam

| | | Less | Less |
|---|---|---|---|
| Ingredient | Preferred | Preferred | Preferred |
| Isocyanate | | | |
| Component | Weight Percent | | |
| Isocyanate (% NCO) | 20-33 | 18-34 | 15-40 |
| | 23 | 16-35 | 14-45 |
| Isocyanate-Reactive | | | |
| Component | Parts per Formula Weight | | |
| Polyol | 98-102 | 90-105 | 80-120 |
| | 95-103 | 85-110 | 75-130 |
| Cross-linking agent | 1.76 | 1.18-2.35 | 1-2.5 |
| | | | 0.5-3 |
| Pigment | 0.9-1.1 | 0.5-5 | 0.1-8 |
| | 1 | | 0-10 |
| Surfactant | 0.85 | 0.5-1.5 | 0.2-1.1 |
| | | | 0.1-1.3 |
| | | | 0-1.5 |
| Blowing agent | 2.4 | 2.3-2.5 | 1.5-4 |
| | | 2-2.6 | |
| Polyurethane catalyst | 0.1-0.25 | 0.1-2 | 0.1-4 |
| | 0.175 | 0.15-3 | |
| Expandable graphite | 20 | 18-22 | 15-25 |
| Halogenated fire- | 20 | 18-22 | 15-25 |
| retardant additive | | | |

Each of the ingredients from Table 1 above will now be discussed. As will be clear below, the fire-retardant polyurethane foam is prepared by mixing the isocyanate component with the isocyanate-reactive component, no other components are needed. That is, It is preferred that the fire-retardant polyurethane foam is a reaction product formed from only the isocyanate and isocyanate-reactive components. The isocyanate-reactive component is preferably only a single component and excludes other components such as additional polyol or isocyanate-reactive components. The fire-retardant polyurethane foam can have an index number (ratio of NCO equivalents in the isocyanate component to the OH equivalents in the isocyanate-reactive component) in the range of 60 to 130, preferably 65 to 110, 70 to 100, or about 70, 75, 80, 85, 90 or 95. Also as discussed herein, the fire-retardant polyurethane foam can have a density of 48 to 112, preferably 64 to 112 and more preferably 64 to 96 kg/m³.

It will be understood that in Table 1 the weight percent concentrations listed for isocyanate (% NCO) are for the isocyanate (NCO) functional groups alone, excluding the weight of the molecule(s) to which the NCO groups are attached. So, for example, if the isocyanate component consists of a blend of allophanate-modified MDI prepolymers, then NCO is present in a concentration of typically 20-30% weight percent.

The isocyanate (NCO) component can be provided in any suitable functional form, including aromatic or aliphatic. For example, it is provided as a liquid material containing two or more reactive NCO sites. Liquid allophanate-modified MDI diisocyanate is a commercially available source of isocyanate. Pure MDI is a solid crystalline substance provided as a white to yellowish powder or flakes. Liquid isocyanate containing materials may also be blends of different isocyanate containing materials. They are provided as a diisocyanate containing two or more reactive NCO sites or other polyisocyanates. For example, the isocyanate component can be a pure or modified 4,4′-bisphenylmethane diisocyanate (methylene bisphenyl diisocyanate (MDI)) combined with allophanate-modified MDI diisocyanate. Blended, allophanate-modified MDI diisocyanate, in one example, is available as Mondur MA-2300 and contains about 23% NCO. This material is commercially available from Bayer Corporation.

Modified MDI products that are liquids are preferred sources of isocyanate. For example, the isocyanate is provided as an allophanate-modified MDI prepolymer. MDI can be reacted with alcohols via a known reaction mechanism to provide the allophanate-modified MDI prepolymers, which have two reactive NCO sites. The allophanate-modified MDI prepolymer can be a liquid at standard temperature and pressure (298 K and 1 atm). This simplifies foam processing and allows for the utilization of conventional foam processing equipment, such as a two-component mixing machine as further discussed below. The allophanate-modified MDI molecule has a concentration of NCO of about 15-30%. Less preferably, other NCO-containing prepolymers known in the art, e.g. other MDI prepolymers, TDI (toluene diisocyanate) prepolymers, mixtures of different types of prepolymers, polymeric MDI, monomeric TDI or blends of polymeric MDI and monomeric TDI may also be used.

In the polyol component or isocyanate-reactive component, the remaining ingredients of the fire-retardant polyurethane foam are provided.

The isocyanate-reactive component can include one or more polyols, which can include any of those as known in the art for the purpose of preparing polyurethane foams, such as propylene oxide (PO) or ethylene oxide (EO) extended polyols such as amine-based polyether polyols. The one or more polyols can have an average molecular weight of from 1000 to 6000 and a hydroxyl number of from 15 to 115. For example, the polyol may be selected from at least one of ethylene glycol, diethylene glycol, propylene glycol, dipropylene glycol, butane diol, glycerol, trimethylolpropane, triethanolamine, pentaerythritol and sorbitol. Further suitable polyols include hydroxyl-terminated polythioethers, polyamides, polyesteramides, polycarbonates, polyacetals, polyolefins and polysiloxanes. Still further, a wide variety of amine-based polyols are known in the art, such as monoethanolamine-based polyether polyols, diethanolamine-based polyether polyols, ethylenediamine-based polyether polyols and triethanolamine-based polyether polyols. Preferably, the amine-based polyether polyol has at least 2, preferably at least 3 or 4 functional reactive sites per molecule.

In one embodiment, the isocyanate-reactive component can include a blend of two or more polyols. For example, a blend of amine-based polyether polyols and styrene-acrylonitrile (SAN) filled PO or EO extended polyether polyols can be used. The amine-based polyether polyols can have a hydroxyl number from 50 to 800, and examples of suitable polyols include Multranol 9138 and 9144, which are commercially available from Bayer Corporation. A blend of two amine-based polyether polyols can be used such that the first amine-based polyether polyol having a hydroxyl number in the range of 500 to 800, preferably 650 to 750 and more preferably about 700 is used at 1 to 15, preferably 2 to 10 and more preferably about 4, 5 or 6 parts per formula weight of the total isocyanate-reactive component. The second amine-based polyether polyol can have a hydroxyl number in the range of 100 to 200, preferably 125 to 175 and more preferably about 150 is used at 45 to 65, preferably 50 to 60 and more preferably about 54, 55 or 56 parts per formula weight of the total isocyanate-reactive component. The SAN-filled polyether polyol can a hydroxyl number in the range of 10 to 50, preferably 15 to 30 and more preferably 18 to 22, and a suitable example includes Hyperlite E-852 having a hydroxyl number of about 20, which is commercially available from Bayer Corporation. The SAN-filled polyether polyol can be used at 30 to 50, preferably 35 to 45 and more preferably about 38 to 42 parts per formula weight of the total isocyanate-reactive component.

The isocyanate-reactive component can further include a cross-linking agent. The cross-linking agent can function to increase the hardness of the fire-retardant polyurethane foam. Examples of cross-linking agents include diethanolamine, diisopropanolamine, triethanolamine and tripropanolamine. Suitable cross-linking agents can also contain a blowing agent, such as water. One suitable cross-linking agent including a blowing agent is Dabco DEOA-LF. In this product, the diethanolamine to water ratio is 85:15. The water is included to prevent the DEOA from freezing and crystallizing before use. This material is commercially available from APCI.

The isocyanate-reactive component can include a pigment. Pigments can include any of those known and used in the art for the purpose of preparing polyurethane foams. For example, black paste is a carbon-based pigment as known in the art. Black paste provides pigmentation to the finished foam product. An example of black paste that can be used is Super Black as supplied by Ferro.

The isocyanate-reactive component can include a surfactant. Surfactants can include any of those known and used in the art for the purpose of preparing polyurethane foams. Surfactants can function as a foam stabilizer or alternatively as a cell-opening agent during foaming. One suitable example of a surfactant for use in the isocyanate-reactive component is silicone. One particular silicone can be SF96-350, which is commercially available from General Electric.

The isocyanate-reactive component can include a blowing agent. The blowing agent can be any of those known and used in the art for the purpose of preparing polyurethane foams. For example, the blowing agent can be water, preferably distilled, deionized water to prevent unwanted impurities from entering the foaming composition and/or interfering with the foam reaction. The water reacts with the isocyanate component to produce CO₂. The production and expansion of CO₂ is responsible for foaming and expansion of the reaction mixture as is generally understood by persons of ordinary skill in the art. Alternatively, other volatile agents can be used such as acetone, halogenated or non-halogenated hydrocarbons or even carbon dioxide.

The isocyanate-reactive component can include one or more polyurethane catalysts to promote foam formation. The polyurethane catalyst can be any of those known and used in the art for the purpose of preparing polyurethane foams. The polyurethane catalyst can be a mixture of catalysts, such as a gel catalyst and a blow catalyst, such as those found to promote a good foaming reaction and a balanced gelling reaction and result in the successful production of the fire-retardant foam product from the components listed in Table 1 above. For example, a tertiary amine, delayed action or trimer gel catalyst can be used. One suitable polyurethane catalyst is a delayed tin/amine gel catalyst, such as Dabco DC-1, which is a combination delayed action tin and delayed action amine catalyst and commercially available from APCI. Other catalysts known in the art may also be used.

Addition of the polyurethane catalyst to the isocyanate-reactive component preferably comes after the expandable graphite and halogenated fire-retardant additive have been added and mixed in the isocyanate-reactive component. For instance, by adding the expandable graphite and halogenated fire-retardant additive in advance of the one or more polyurethane catalysts, the halogenated fire-retardant additive can coat or plug up the expandable graphite such that less catalyst is needed to prepare the fire-retardant foam and that the expandable graphite does not adsorb the catalyst as described below.

As shown in Table 1, the isocyanate-reactive component includes a combination, or fire-retardant additive package, of expandable graphite and a halogenated fire-retardant additive. The fire-retardant additive package of the isocyanate-reactive component preferably consists of only a halogenated fire-retardant additive and expandable graphite having an average particle size diameter greater than 350 microns. The combination of expandable graphite and a halogenated fire-retardant additive can be used in the isocyanate-reactive component in the range of 30 to 50, 35 to 45 or about 40 parts per formula weight of the total isocyanate-reactive component. It is preferred that the expandable graphite used has an average particle diameter of at least or equal to or more than 250, preferably 275, preferably 300 preferably 325 and more preferably 350 microns. For example, Asbury Carbon No. 3772 can be used as the expandable graphite ingredient, which is commercially available from Asbury Graphite Mills, Inc. Asbury Carbon No. 3772 is a solid free-flowing flake or powder product having an average particle diameter of about 350 microns, 46 mesh.

The halogenated fire-retardant additive is preferentially adsorbed on the surface of the expandable graphite such that the graphite becomes coated with the halogenated additive. Preferably, the fire-retardant additive is halogenated with chlorine or bromine. More preferably, the fire-retardant additive is a halogenated phosphate, such as a chlorinated phosphate, for example, a di- or tri-chloro phosphate. Examples of halogenated fire-retardant additives for use with expandable graphite include pentabromodiphenyl oxide, tris-(chloroisopropyl) phosphate, tris-(1,3-dichloroisopropyl) phosphate and tris-(chloroethyl) phosphate. One suitable halogenated fire-retardant additive that can be used is tris-(chloroisopropyl) phosphate, supplied as Levagard PP-Z, which is commercially available from Lanxess. Although halogenated fire-retardant additives are generally disfavored under normal circumstances, as described below, it is the halogenated fire-retardant additive that provides a synergistic effect when combined with the expandable graphite to yield a stable isocyanate-reactive component having improved pot life. Extended pot life allows the isocyanate-reactive component to be used after being mixed and allowed to recycle under low pressure for 1 to 2 hours without losing its reactive characteristics with the isocyanate component. As further shown in the examples below, non-halogenated fire-retardant additives, either used alone or in combination with expandable graphite do not provide a stable isocyanate-reactive component suitable for the industrial scale production of fire-retardant polyurethane foams.

It will be understood that additional ingredients that are known or conventional in the art can be added in conventional amounts to either the isocyanate component or isocyanate-reactive component described. Such additional ingredients may be selected by a person having ordinary skill in the art to impart additional desired properties to the invented fire-retardant polyurethane foam without substantially detracting from its improved and novel characteristics.

The unique characteristics of the combination of expandable graphite and halogenated fire-retardant additive are now described. Preparing the fire-retardant polyurethane foam of the present invention eliminates the need for splitting the isocyanate-reactive component into separate individual feedstocks to be combined shortly before the isocyanate component is added to initiate the foam reaction. For example, the expandable graphite or halogenated fire-retardant additive does not have to be initially mixed with only some of the isocyanate-reactive component and then later combined with the remaining portion of the isocyanate-reactive component until shortly before the reaction with isocyanate. Nor does the isocyanate-reactive component of the present invention have to be prepared shortly before the isocyanate component is reacted in order to avoid prolonged storage or pot time of the isocyanate-reactive component. The isocyanate-reactive component has a storage life or pot life of at least 1 hour, preferably at least 1.5 hours and more preferably at least 2 hours. Storage or pot life is measured by the amount of time the isocyanate-reactive component can remain in a storage container, such as a feedstock tank, prior to being mixed with the isocyanate component to produce a reaction product that is a fire-retardant polyurethane foam that passes the FAA burn test. Pot life is measured by the amount of time the isocyanate-reactive component can be stored and retain its reactivity with the isocyanate component. Loss of reactivity associated with prior art polyol mixtures is overcome by the novel isocyanate-reactive component having the unique fire-retardant additive package described herein.

The novel fire-retardant additive package provides an isocyanate-reactive component that can be used to produce a fire-retardant polyurethane foam that passes the FAA burn test not only in hand-made, bench-scale batches, but also in commercial or industrial-scale batches using automated foam-making equipment as discussed below, such as a two-component mixing machine, without resorting to either the complexity of processing a foam with an extruder or the expense and difficult processing associated with a three-component foam mixing machine. Thus, the fire-retardant additive package provides certain advantages over prior art formulations and processes for preparing polyurethane foams.

Without being bound by theory, the halogenated fire-retardant additive is preferentially adsorbed by the expandable graphite, thus preventing the graphite from acting as an adsorbent of small molecules, for example adsorbing molecules of catalyst which can have lone pair electrons on available nitrogen or have a positive or negative charge on a metal or its counter ion. For instance, during the foam making process, the formation of urethane bonds to produce molecular bridges between the polyols of the isocyanate-reactive component and the isocyanate component is generally referred to as gellation. While the reaction between isocyanate and the isocyanate-reactive component is thermodynamically favored, it can be relatively slow and thus balanced polyurethane catalysts are conventionally used to increase the reaction rate. Because expandable graphite can function as an adsorbent of the catalysts, addition of expandable graphite was either initially mixed with only some of the polyol, preferably water-free, to be used in the foam reaction or, the expandable graphite was mixed with all of the foam ingredients shortly before the reaction with isocyanate. The halogenated fire-retardant additive is preferentially adsorbed by the expandable graphite. This adsorption reduces the ability of the graphite to adsorb the remaining small molecules because the preferential adsorption of the halogenated fire-retardant additive functions to block the surface of the expandable graphite. The halogenated fire-retardant additive can be added to the isocyanate-reactive polyol component along with the expandable graphite prior to the addition of the other ingredients that might be adsorbed by the expandable graphite, such as a foam catalysts.

To reduce the amount of surface area of the expandable graphite used (which can control the amount of halogenated fire-retardant additive needed to be preferentially adsorbed by the graphite) it is preferred to use the expandable graphite having average particle diameters as disclosed above. Using smaller-diameter graphite can increase the amount of halogenated fire-retardant additive needed and detract from the improved and novel characteristics of the fire-retardant polyurethane foam and process to prepare the same.

The synergistic effect of the expandable graphite and halogenated fire-retardant additive surprisingly and unexpectedly produces a stable isocyanate-reactive component containing the non-isocyanate foam ingredients wherein the stable isocyanate-reactive component has increased storage or pot life and can be used to produce fire-retardant polyurethane foams that pass the FAA burn test. Thus, the combination of expandable graphite having an average diameter of at least 250 microns or more and a halogenated fire-retardant additive provides a synergistic preservative effect to the single isocyanate-reactive component used to prepare the foam and reduces the reaction degradation associated with the prior art examples. By contrast, although expandable graphite and halogenated fire-retardant additives are known for use in fire-retardant foams, when used alone the expandable graphite or a halogenated fire-retardant additive do not produce a polyurethane foam that can be made on an industrial scale with a two-component mixing machine and that pass the FAA burn test. Not only does the expandable graphite or halogenated fire-retardant additive when used alone not produce a polyurethane foam that passes the FAA burn test, but the expandable graphite does not result in a stable isocyanate-reactive component that has a storage or pot life of at least 1 hour or more. It has been discovered that the combination of the expandable graphite and halogenated fire-retardant additive provides a longer-lasting and stable isocyanate-reactive component that has a storage or pot life greater than which would be expected or predicted form the additive effect of the individual ingredients. As further discussed in the examples below, it was discovered that combinations of expandable graphite having varying average particle sizes with other known fire-retardant additives did not produce a fire-retardant polyurethane foam that passes the FAA burn test.

The fire-retardant polyurethane foam is suitable for industrial-scale production on conventional foam processing equipment, and preferably with a two-component mixing machine, which further preferably only accommodates two components, such as the isocyanate and isocyanate-reactive components, and excludes ports or mixing chambers for additional components. The isocyanate and isocyanate-reactive components generally complete reaction in 1 to 3 minutes or less. It is preferred, as an industrial scale process, to simultaneously combine or mix or add together the liquid isocyanate component and the liquid isocyanate-reactive component into a desirable container as known in the art in order to allow the mixed components to react and form a fire-retardant polyurethane foam. The components can be turbulently mixed by the foam machine or two-component mixing head or mix-head device to deliver a controlled feed or flow of reaction mixture consisting of the isocyanate component and isocyanate-reactive component to the foam housing container, such as an open box or a mold as is known in the art. For example, a two-component mixing head can provide high-pressure mixing of the isocyanate and isocyanate-reactive components in an impingement chamber and allow for accurate and controlled application of the foam reaction mixture to a container. A preferred mixing device is a two-component mixing head, such as the Delta RIM model provided by Gusmer-Decker of Graco.

The isocyanate and isocyanate-reactive components preferably have viscosities that are suitable for liquid mixing such that the reaction mixture can be sprayed, injected or poured into containers, such as a mold or box. Suitable viscosities facilitate the pumping of the components into a spray nozzle, mix-head device or similar mixing valve so the components can be mixed and combined to react in the foam container.

In a preferred embodiment, the foam processing equipment is provided in moveable form such that the operator can manipulate the two-component mixing head throughout the foam processing area and reach multiple foam containers where the reaction mixture is to be dispensed or sprayed. Feedstock tanks or mixing vessels can be used to house the isocyanate and isocyanate-reactive components. The feedstock tanks can be fluidly connected to the foam mixing machine with any suitable equipment such as a hose, tube or similar flexible conduit. The isocyanate and isocyanate-reactive components can be pumped or metered using hydraulically driven cylinders to transfer or meter the components to a standard high-pressure foam machine. The feedstock tanks can be heated to control the temperature of either of the components, or alternatively, a preheater, such as a heat exchanger, can be included as in-line equipment between the feedstock tank and the foam machine to adjust temperature of either of the components and further control the foaming reaction temperature. The foam reaction temperature used to prepare the fire-retardant polyurethane foam as described herein can be in the range of 25 to 41, preferably 25 to 35 or about 30° C.

### EXAMPLES

### Example 1

An exemplary fire-retardant polyurethane foam composition and process for preparing the foam will now be described. Also described are two comparative polyurethane foam compositions that do not pass the FAA burn test. The exemplary fire-retardant and comparative foams each have an index of about 100 (one isocyanate equivalent for each hydroxyl equivalent). The compositions of the foams are listed in Table 2 below. The isocyanate-reactive ingredients are provided in parts per formula weight (PFW) of the total isocyanate-reactive component.

TABLE 2
Isocyanate Component and Isocyanate-Reactive Component for Fire-
Retardant Polyurethane Foam and Comparative Foam Examples

| Ingredient (description)/ | | |
|---|---|---|
| Foam characteristics | | |
| Fire- | Compar- | Compar- |
| Retardant | ative | ative |
| Foam | Foam 1 | Foam 2 |

Isocyanate-Reactive Component (PFW)

| | | | |
|---|---|---|---|
| Levagard PP-Z | 20 | — | 20 |
| (tris-(chloroisopropyl) | | | |
| phosphate, halogenated | | | |
| fire retardant) | | | |
| Antiblaze 117 HF (triphenyl | — | 20 | — |
| phosphate, non-halogenated fire | | | |
| retardant) | | | |
| Grafguard 160/80N (expandable | — | — | 20 |
| graphite, 80 mesh, average | | | |
| particle diameter of 180 microns) | | | |
| Asbury Carbon No. 3772 | 20 | 20 | — |
| (expandablegraphite, 46 mesh, | | | |
| average particle diameter of | | | |
| 350 microns) | | | |
| Multranol 9138 (amine-based | 5 | 5 | 5 |
| polyether polyol, OH number | | | |
| of about 700) | | | |
| Multranol 9144 (amine-based | 55 | 55 | 55 |
| polyether polyol, OH number | | | |
| of about 150) | | | |
| Hypeerlite E-852 (SAN-filled | 40 | 40 | 40 |
| PO/EO-extended polyether | | | |
| polyol, OH numbr of about 20) | | | |
| DEOA-LF (85% diethanolamine/ | 1.765 | 1.765 | 1.765 |
| 15% water, cross-linking agent) | | | |
| Super Black (black paste pigment) | 1 | 1 | 1 |
| GE SF96-350 (silicone surfactant) | 0.85 | 0.85 | 0.85 |
| Water (blowing agent) | 2.36 | 2.36 | 2.36 |
| Dabco DC-1 (combination | 0.175 | 0.175 | 0.175 |
| delayed action tin/delayed action | | | |
| amine gel catalyst) | | | |

Isocyanate Component (PHP NCO)

| | | | |
|---|---|---|---|
| Parts per hundred (PHP) | 70.95 | 70.95 | 70.95 |
| Mondur MA-2300 (isocyanate) | | | |

Foam/Isocyanate-Reactive Component Characteristics

| | | | |
|---|---|---|---|
| Isocyanate-reactive component | at least 2 | less | less |
| pot life (hours) | | than 0.25 | than 0.25 |
| Foam Density (kg/m³) | 64 | Foam | Foam |
| | | collapse | collapse |
| Foam Type | Semi-rigid, | Collapsed | Collapsed |
| | viscoelastic | | |
| Foam-FAA 25.853 Appendix F, | Passes | Not Tested | Not Tested |
| Part 1 burn test | | | |

The fire-retardant foam and comparative foam examples 1 and 2 were prepared using the same process as described below. The isocyanate-reactive component was prepared in a mix-tank by adding each ingredient to the mix-tank, wherein the expandable graphite and halogenated fire-retardant additive were added in advance of the catalyst. The ingredients of the isocyanate-reactive component were mixed together for 10 minutes at a speed of 300 rpm in the tank to prepare a single polyol-containing component for reaction with the isocyanate component, or a two-part fire-retardant foam reaction mixture consisting of only the isocyanate and isocyanate-reactive components. The isocyanate-reactive component tank had a volume of 90 gallons and mixing was facilitated with a Binks agitator. The isocyanate-reactive component high-pressure tank of 60 gallons was fluidly connected to a two-component Delta RIM mixing head, supplied by Gusmer-Decker of Graco such that the isocyanate-reactive component was metered at a pressure of 2100 psi into the mixing head using hydraulically driven cylinders. The isocyanate component was hydraulically metered to the mixing head from a high-pressure tank having a volume of 60 gallons.

The Gusmer-Decker high-pressure, two-component mixing head was used to pour the reaction mixture of the isocyanate-reactive component and the isocyanate component into open box foam containers measuring 0.5×0.5×0.5 m. The gel time amounted to 90 to 100 seconds and the rise time amounted to 90 to 100 seconds. After 15 minutes, the reaction products were taken out of the open box containers to provide semi-rigid foams.

The fire-retardant foam sample was subjected to the burn test as specified by FAA 25.853 Appendix F, Part 1. Because the comparative foam samples, 1 and 2, collapsed and did not result in a viable foam, they were not tested. As can be seen, the only isocyanate-reactive component that provided a polyurethane foam that passed the FAA burn test contained a combination of expandable graphite, 46 mesh, average particle size of 350 microns and a halogenated fire-retardant additive, namely tris-(chloroisopropyl) phosphate. The combination of 20 PFW expandable graphite, 46 mesh, average particle size of 350 microns and 20 PFW halogenated fire-retardant additive also was the only fire-retardant additive package that yielded extended pot life in the magnitude of at least 2 hours. Based on the test results, it was determined that the novel combination of expandable graphite having an average particle diameter of at least 350 microns and a halogenated fire-retardant additive, each at about 20 PFW of the isocyanate-reactive component, can produce polyurethane foams on an industrial scale process utilizing a two-component foam machine and that pass the FAA burn test as noted above.

By contrast, comparative foam 1 contained a combination of 20 PFW expandable graphite, 46 mesh, average particle size of 350 microns and 20 PFW non-halogenated fire-retardant additive collapsed and did not produce a fire-retardant polyurethane foam. The remaining ingredients and amounts thereof were the same as for the fire-retardant foam of Table 2. It was determined that the halogenated fire-retardant additive was preferentially adsorbed by the larger diameter graphite such that a fire-retardant polyurethane foam could be produced.

Comparative foam 2 contained a combination of 20 PFW halogenated fire-retardant additive and 20 PFW of expandable graphite, 80 mesh, average particle size of 180 microns but did not produce a fire-retardant polyurethane foam. The remaining ingredients and amounts thereof were the same as for the fire-retardant foam of Table 2. It was determined that the smaller diameter expandable graphite, for example less than 200 microns, provided an increase in surface area that could not be effectively coated by the halogenated fire-retardant additive. Increasing the halogenated fire-retardant additive to accommodate the increased surface area would likely alter the foam characteristics in an undesirable manner and increase ingredient costs. It was further determined that expandable graphite at 20 PFW having a average particle diameter of at least 250 microns, preferably 300 microns and more preferably at least 350 microns in combination with 20 PFW of a halogenated fire-retardant additive can not only produce a fire-retardant polyurethane foam as tested above but also increases the pot life of the isocyanate-reactive component.

As will be clear below in Example 2, the combination of expandable graphite having an average particle diameter of at least 350 microns and a halogenated fire-retardant additive, each at about 20 PFW of the isocyanate-reactive component, uniquely provides an isocyanate-reactive component suitable for industrial-scale production as compared to hand-mixed, bench-top experiments as routinely conducted in the prior art. Moreover, as described in Example 3, known fire-retardant additives when used alone in hand-mixed experiments do not produce a fire-retardant polyurethane foam that passes the FAA burn test.

### Example 2

Described below are two hand-mixed comparative polyurethane foam compositions that pass the FAA burn test. The comparative foams each have an index of about 100 (one isocyanate equivalent to one hydroxyl equivalent). The compositions of the foams are listed in Table 3 below. The isocyanate-reactive ingredients are provided in parts per formula weight (PFW) of the total isocyanate-reactive component.

TABLE 3
Isocyanate and Isocyanate-Reactive Components for Comparative Foam Examples
Hand-Mixed Foams

| Ingredient (description)/ | |
|---|---|
| Foam characteristics | |
| Comparative | Comparative |
| Foam 3 | Foam 4 |

Isocyanate-Reactive Component (PFW)

| | | |
|---|---|---|
| Levagard PP-Z (tris-(chloroisopropyl) phosphate, | — | 20 |
| halogenated fire retardant) | | |
| Antiblaze 117 HF (triphenyl phosphate, non-halogenated | 20 | — |
| fire retardant) | | |
| Grafguard 160/80N (expandable graphite, 80 mesh, | | |
| average particle diameter of 180 microns) | 20 | 20 |
| Multranol 9138 (amine-based polyether polyol, OH | | |
| number of about 700) | 5 | 5 |
| Multranol 9144 (amine-based polyether polyol, OH | | |
| number of about 150) | 55 | 55 |
| Hypeerlite E-852 (SAN-filled PO/EO-extended polyether | | |
| polyol, OH numbr of about 20) | 40 | 40 |
| DEOA-LF (85% diethanolamine/15% water, cross-linking | 1.765 | 1.765 |
| agent) | | |
| Super Black (black paste pigment) | 1 | 1 |
| GE SF96-350 (silicone surfactant) | 0.85 | 0.85 |
| Water (blowing agent) | 2.36 | 2.36 |
| Dabco DC-1 (combination delayed action tin/delayed | 0.175 | 0.175 |
| action amine gel catalyst) | | |

Isocyanate Component (PHP NCO)

| | | |
|---|---|---|
| Parts per Hundred Polyol (PHP) | 70.95 | 70.95 |
| Mondur MA-2300 (isocyanate) | | |

Foam Characteristics

| | | |
|---|---|---|
| Foam Density (kg/m³) | 64 | 64 |
| Foam Type | Semi-rigid, | Semi-rigid, |
| | viscoelastic | viscoelastic |
| Foam-FAA 25.853 Appendix F, Part | Passes | Passes |
| 1 burn test | | |

The comparative foam examples 3 and 4 were prepared using the same hand-mix, bench-scale process as described below. The isocyanate-reactive component was prepared by weighing the ingredients in a one quart polypropylene container (the catalysts being added last) and stirring the mixture for 60 seconds. The appropriate amount of isocyanate-reactive blend was then weighed into a paper container. The isocyanate component was then added to the isocyanate-reactive component in the paper container and the foam reaction mixture was stirred for 15 seconds at 2000 rpm using a mechanical agitator. The two-component foam reaction mixture was then poured into a 30 by 30 by 30 cm open box. The foams were allowed to rise under free-rise conditions and then the polyurethane foams were removed for testing.

Each foam sample was subjected to the FAA burn test. As can be seen, the hand-mixed, bench-scale process produced polyurethane foams that passed the FAA burn test. The results also showed that 20 PFW expandable graphite having an average particle diameter of 180 microns could be used with either 20 PFW non-halogenated or halogenated fire-retardant additive to produce a fire-retardant polyurethane foam. Because the bench-top foam samples passed the FAA burn test, it was surprising and unexpected that scaling up comparative foam 4 to an industrial scale process using a two-component mixing head did not produce a similar fire-retardant foam as indicated in the results for comparative foam 2 as described in Example 1 above. The results of Examples 1 and 2 show that hand-mixed, bench-top experiments do not indicate or predict success for scaling up compositions to be prepared using an industrial scale process utilizing a two-component mixing machine such as described in Example 1. For example, bench-top experiments generally do not require the isocyanate-reactive components to be stored in a container for prolonged periods of time as may be the case with an industrial scale process. The ingredients in a bench-top experiment are mixed together and reacted with the isocyanate component relative quickly, for instance less than 1 to 3 minutes. Example 3 below further shows that bench-top experiments evaluating fire-retardant additives are not suitable for predicting or selecting what fire-retardant additives or combination of additives can produce a stable isocyanate-reactive component having improved pot life or a fire-retardant polyurethane foam produced by an industrial scale process that passes the FAA burn test described herein.

### Example 3

### Examples with Single Fire Retardant Additives

Described below are 16 hand-mixed comparative polyurethane foam compositions containing various fire-retardant additives, of which only 2 provide foam samples that periodically pass the FAA burn test. The comparative foams each have an index of about 100 (one isocyanate equivalent to one hydroxyl equivalent). The fire-retardant additive used in comparative foam is listed in Table 4 below. The remaining ingredients of the isocyanate-reactive component are the same as those listed in Examples 1 and 2 and were used in the same amounts as indicated in the examples. The comparative foams of this example also were prepared by the same hand-mix, bench-top process as described in Example 2 above. The fire-retardant additive amounts are provided in parts per formula weight (PFW) of the total isocyanate-reactive component.

TABLE 4
Isocyanate and Isocyanate-Reactive Components for Comparative Foam Examples

| | | | Amount (PFW) in | |
|---|---|---|---|---|
| Example | Fire Retardant Material | | Isocyanate-Reactive | FAA 25.853 Appendix |
| No. | (description) | Supplier | Component | F, Part 1 burn test |
| 1 | Firemaster 600 | Chemtura | 20 | Fails |
| | (phosphorous-bromine) | | | |
| 2 | Disflamol DPK (diphenyl | Lanxess | 15 | Fails |
| | cresyl phosphate) | | | |
| 3 | Levaguard PP-Z (tris- | Lanxess | 15 | Passes Sometimes |
| | (chloroisopropyl) phosphate) | | | |
| 4 | Fryol FR-2 (tris-(1,3- | Supresta | 18 | Fails |
| | dichloroiospropyl) | | | |
| | phosphate) | | | |
| 5 | Fryol 38 (tris-(1,3- | Supresta | 18 | Fails |
| | dichloroiospropyl) phosphate | | | |
| | blend) | | | |
| 6 | Fryol PCF (tris (2- | Supresta | 15 | Passes Sometimes |
| | chloroisopropyl) phosphate) | | | |
| 7 | Antiblaze 117 HF (triphenyl | Albemarle | 15 | Fails |
| | phosphate) | | | |
| 8 | Antiblaze VE-95 (chlorinated | Albemarle | 15 | Fails |
| | and brominated phosphate | | | |
| | ester) | | | |
| 9 | Fryol PNX (oligomeric alkyl | Supresta | 15 | Did not produce testable |
| | phosphate) | | | foam (bad reactivity) |
| 10 | Zinc Borate | 20 Mule Team Borax | 15 | Fails |
| 11 | Melamine MP501 | Self-supplied in house | 15 | Fails |
| | (melamine) | | | |
| 12 | Grafguard 160/80N | UCAR Carbon | 15 | Fails |
| | (expandable graphite, 80 | | | |
| | mesh, average particle | | | |
| | diameter of 180 microns) | | | |
| 13 | Asbury No. 3393 | Asbury Carbon | 15 | Fails |
| | (expandable graphite, 50 | | | |
| | mesh, average particle | | | |
| | diameter of 340 microns) | | | |
| 14 | Asbury No. 3494 | Asbury Carbon | 15 | Fails |
| | (expandable graphite, 160 | | | |
| | mesh, average particle | | | |
| | diameter of 107 microns) | | | |
| 15 | Asbury No. 3772 | Asbury Carbon | 15 | Fails |
| | (expandable graphite, 46 | | | |
| | mesh, average particle | | | |
| | diameter of 350 microns) | | | |
| 16 | Asbury No. 3626 | Asbury Carbon | 15 | Fails |
| | (expandable graphite, 143 | | | |
| | mesh, average particle | | | |
| | diameter of 118 microns) | | | |

Each foam sample was subjected to the FAA burn test. As can be seen, the hand-mixed, bench-scale process using only one fire-retardant additive in each composition did not produce polyurethane foams that consistently pass the FAA burn test. For example, the addition of expandable graphite having varying average particle size diameters did not produce a fire-retardant polyurethane foam. Of the 6 halogenated fire-retardant additives used, namely Firemaster 600, Levaguard PP-Z, Fryol FR-2, Fryol 38, Fryol PCF and Antiblaze VE-95, only 2 additives produced a polyurethane foam that occasionally passed the FAA burn test.

The results of Example 3 show that hand-mixed, bench-top experiments evaluating individual fire-retardant additives are not suitable for predicting or selecting what fire-retardant additives or combination of additives can produce a stable isocyanate-reactive component having improved pot life or a fire-retardant polyurethane foam produced by an industrial scale process that passes the FAA burn test described herein. Further, the results of Example 3 show that the average particle size diameter of expandable graphite does not indicate or predict what expandable graphite or combination of expandable graphite and another fire-retardant additive can produce a fire-retardant polyurethane foam produced by an industrial scale process that passes the FAA burn test. It was surprising and unexpected that in Example 1 expandable graphite having an average particle size diameter of 350 microns could be combined with a halogenated fire-retardant additive to produce a fire-retardant polyurethane foam whereas smaller diameter expandable graphite having an average particle size diameter of less than 200 microns did not produce such a fire-retardant polyurethane foam.

While various embodiments in accordance with the present invention have been shown and described, it is understood the invention is not limited thereto, and is susceptible to numerous changes and modifications as known to those skilled in the art. Therefore, this invention is not limited to the details shown and described herein, and includes all such changes and modification as encompassed by the scope of the appended claims.

What is claimed is:

1. A process for preparing a fire-retardant polyurethane foam comprising:
preparing a single isocyanate-reactive component comprising mixing at least one polyol, expandable graphite having an average particle size of at least 250 microns and a halogenated fire-retardant additive;
providing an isocyanate component;
mixing said single isocyanate-reactive component and said isocyanate component to initiate a foaming reaction to produce a fire-retardant polyurethane foam, wherein said foam passes the burn test of FAA 25.853 Appendix F, Part 1.

2. The process of claim 1, said single isocyanate-reactive component comprising 15 to 25 parts per formula weight of said expandable graphite having an average particle size of at least 250 microns and 15 to 25 parts per formula weight of said halogenated fire-retardant additive, wherein said parts per formula weight are based on the total weight of said single isocyanate-reactive component.

3. The process of claim 2, said single isocyanate-reactive component having not more that a total of 50 parts per formula weight of a fire-retardant additive or combination of fire-retardant additives.

4. The process of claim 2, said expandable graphite having an average particle size of at least 350 microns.

5. The process of claim 2, said halogenated fire-retardant additive being a chlorinated phosphate.

6. The process of claim 2, said chlorinated phosphate being tris-(chloroisopropyl) phosphate.

7. The process of claim 1, said single isocyanate-reactive component further comprising 0.1 to 4 parts per formula weight of a polyurethane catalyst, wherein said parts per formula weight is based on the total weight of said single isocyanate-reactive component.

8. The process of claim 1, said fire-retardant polyurethane foam being a reaction product of two components consisting of said single isocyanate-reactive component and said isocyanate component.

9. The process of claim 1, said single isocyanate-reactive component and said isocyanate component being mixed with a two-component mixing machine.

10. The process of claim 9, said two-component mixing machine employing a mix-head capable of delivering a controlled flow of a mixed stream of said single isocyanate-reactive component and said isocyanate component.

11. The process of claim 9, preparing said single isocyanate-reactive component in a tank and feeding said single isocyanate-reactive component from said tank to said two-component mixing machine.

12. The process of claim 1, said single isocyanate-reactive component having a pot life of at least one hour.

13. The process of claim 12, said single isocyanate-reactive component having not more than two fire-retardant ingredients, said fire-retardant ingredients consisting of 15 to 25 parts per formula weight of said expandable graphite having an average particle size of at least 250 microns and 15 to 25 parts per formula weight of said halogenated fire-retardant additive.

14. A process for preparing a fire-retardant polyurethane foam comprising:
introducing an isocyanate-reactive component having a pot life of at least one hour into a two-component mixing machine, wherein said isocyanate-reactive component comprises 70 to 130 parts per formula weight of one or more polyols, 15 to 25 parts per formula weight of expandable graphite having an average particle size of at least 250 microns, 15 to 25 parts per formula weight of a halogenated phosphate fire-retardant additive, and 0.1 to 4 parts per formula weight of a polyurethane catalyst;
introducing an isocyanate component into said two-component mixing machine;
using said two-component mixing machine to mix said isocyanate-reactive component and said isocyanate component to form a fire-retardant polyurethane foam that passes the burn test of FAA 25.853 Appendix F, Part 1.

15. The process of claim 14, said chlorinated phosphate fire-retardant additive being selected form the group consisting of tris-(chloroisopropyl) phosphate, tris-(1,3-dichloroisopropyl) phosphate and tris-(chloroethyl) phosphate.

16. The process of claim 14, said two-component mixing machine being a mix-head device capable of delivering a controlled flow of a mixed stream of said isocyanate-reactive component and said isocyanate component.

17. A fire-retardant polyurethane foam comprising:
a reaction product formed from two components consisting of an isocyanate-reactive component and an isocyanate component, said isocyanate-reactive component comprising 70 to 130 parts per formula weight of one or more polyols, 15 to 25 parts per formula weight of expandable graphite having an average particle size of at least 250 microns, 15 to 25 parts per formula weight of a halogenated fire-retardant additive, 0.1 to 4 parts per formula weight of a polyurethane catalyst, wherein said fire-retardant polyurethane foam passes the burn test of FAA 25.853 Appendix F, Part 1.

18. The fire-retardant polyurethane foam of claim 17, said isocyanate-reactive component having a pot life of at least one hour.

19. The fire-retardant polyurethane foam of claim 17, providing said reaction product by using a two-component mixing machine to mix said isocyanate-reactive component and said isocyanate component.

20. The fire-retardant polyurethane foam of claim 19, said two-component mixing machine being a mix-head device capable of delivering a controlled flow of a mixed stream of said isocyanate-reactive component and said isocyanate component.
